(19) United States
(12) Patent Application Publication
(10) Pub. No.: US 2026/0042672 A1
(43) Pub. Date: Feb. 12, 2026

(54) MULTIFUNCTIONAL NANO COMPOSITES BASED ON ALIGNMENT OF GRAPHENE NANOPLATELETS

(71) Applicant: The Board of Regents for the Oklahoma Agricultural and Mechanical Colleges, Stillwater, OK (US)

(72) Inventors: Raman Singh, Tulsa, OK (US); Sai Tharun Kotikalapudi, Tulsa, OK (US)

(21) Appl. No.: 19/363,337

(22) Filed: Oct. 20, 2025

Related U.S. Application Data
(63) Continuation of application No. PCT/US2024/025184, filed on Apr. 18, 2024.

(51) Int. Cl. C01B 32/194; C08K 7/00

(52) U.S. Cl. CPC C01B 32/194; C08K 7/00; C01B 2204/22; C01P 2006/40; C08K 2201/001; C08K 2201/011

(57) ABSTRACT

A composition comprising graphene nanoplatelets in a matrix material and a method of aligning graphene nanoplatelets in a matrix material, wherein the method includes dispersing the graphene nanoplatelets in a liquid precursor to produce a dispersion. Afterward, the dispersion is cured while applying an electric field to the dispersion in two orthogonal directions. The electric field is rotated so as not to be applied simultaneously in both directions so as to produce a composition comprising planar-aligned graphene nanoplatelets in the matrix material.

### CROSS-REFERENCE TO RELATED APPLICATION

This application is a continuation of PCT/US24/25184, filed on Apr. 18, 2024, which claims the benefit of U.S. Provisional Application 63/460,720 filed Apr. 20, 2023, both of which are hereby incorporated by reference.

### STATEMENT REGARDING FEDERALLY SPONSORED RESEARCH OR DEVELOPMENT

This invention was made with government support under FA9550-20-1-0156 awarded by Department of Defense. The government has certain rights in the invention.

### BACKGROUND

Graphene nanocomposites have been successfully implemented in manufacturing industries due to their ease of processing, lower costs, and their capability to amplify thermal, electrical, and mechanical properties simultaneously. Due to these incredible properties, graphene has been extensively used for many applications ranging from high-performance energy storage devices such as supercapacitors and multifunctional batteries to electronic devices for anti-static coatings and electromagnetic shielding, lightning strike protection, microwave absorption, dielectric material in electronics. Addition of graphene to polymers has a significant impact on its electrical and thermal conductivities, mechanical properties, and polymer flexibility.

Graphene is a 2D allotrope of carbon with a unique honeycomb lattice that contributes to its excellent electron mobility and thermal conductivity. The presence of sp² bonds between its hexagonal arrangement of carbon atoms provides highly mobile π electrons that are responsible for graphene's exceptional electrical conductivity (6×10⁵ S/m). Several of these two-dimensional layers of monolayer graphene stack upon each other using van der Waals forces, forming a graphene nanoplatelet (GNP). GNPs are widely used as a filler material in polymer matrices due to its remarkable properties, such as high electrical and thermal conductivities as well as high tensile strength and Young's modulus. These particles also exhibit anisotropic properties with significantly improved electrical and thermal conductivities parallel to the surface.

Although, GNPs are widely used as nanofillers for various polymer nanocomposites, the resulting properties are significantly lower than the analytically predicted properties. The primary reasons are the agglomeration of particles which leads to ineffective nano-scale regions and thelack of control of the orientation of these particles in the nanocomposites.

GNPs exhibit significantly improved properties along the planar direction compared to through thickness direction. Due to their unique shape (oblate spheroid), they have a very high aspect ratio (600-10000) which results in a higher surface area. The high surface area facilitates greater interactions with the host polymer, phonon transport, electrical and thermal conductivity. However, the high surface area gives rise to significant Van der Waals forces and π-π interactions. These forces often result in agglomeration and stacking of GNP particles which reduces the effectiveness of an individual particle, causing a detrimental effect on the performance of the nanocomposite. In addition to this, the performance of the GNP nanocomposite highly depends on the orientation of the GNPs due to their substantial difference in properties along the plane and through-thickness direction and random orientation of GNPs tend to neutralize this effect.

Present-day manufacturing techniques of these nanocomposites result in random dispersion of these particles promoting agglomeration and restricting the usage of higher concentrations. Also, randomly oriented particles tend to neutralize the anisotropic property advantage if the statistical average is considered. To effectively use GNP's anisotropic properties, modulation of its orientation must be controlled by utilizing appropriate manufacturing processes. These methods can ensure significantly improved directional properties with low concentrations of GNPs. There have been several methods of controlling the orientation of anisotropic particles such as liquid crystal method, electric field, solvent extraction, and magnetic field. Of these electric field and magnetic field can be used without any solvent or surfactants. However, the usage of magnetic fields is restricted to magnetic nanoparticles and the necessity of high magnetic fields. The most widely reported method for aligning GNPs was using an external electric field due to its ease of processing conditions and the ability to modulate the degree of orientation. Several studies have demonstrated the beneficial effects on the mechanical, electrical, thermal and fracture properties of nanocomposites resulting from aligning graphene platelets through an external electric field.

One study aligned multilayer graphene flakes in epoxy with an external electric field to improve multifunctional properties of graphene composites such as directional electrical conductivity, thermal conductivity, and fracture toughness. Another studied the growth of mechanical elasticity and DC electrical conductivity of poly (lactic acid) composite containing 0.34 vol % of GNPs under the application of a strong electric field at a low frequency of 60 Hz. These works were done for very low weight fractions (0.054 and 0.028 vol %). However, these models fail to predict the same for higher weight fractions of GNP, because the behavior becomes complex as particle-to-particle interactions and viscosity increases proportionally.

Apart from electrical properties, mechanical properties can also be increased by orienting graphene. A study used a DC electric field to align 0.3 wt % of graphene oxide nanoplatelets (GONPs) in epoxy to improve the fracture behavior of adhesive joints. It achieved a 56% increase in the maximum load of adhesive joints compared to unaligned adhesive joints. However, the application of DC fields can lead to permanent migration of particles to the electrodes of the applied field due to directed movement, resulting in unwanted electrophoretic deposition. GONPs were aligned in polyethersulfone films and an increase of 24% in tensile strength was noticed for 0.1 wt % concentration. TEM also revealed that higher loadings (1-2 wt %) resulted in larger agglomerations which could not be oriented perfectly along the electric field.

In all cases, due to the lack of control of chain formation, agglomeration of particles along the chains takes place as the electric field is continuously applied. This results in ineffective usage of GNPs as agglomeration along the chains reduces the surface area for adhesion. Moreover, alignment induces property advantages along the through-thickness direction which is the electric field direction, and the transverse properties remain unaltered. One observed a 2-3 order increase in DC electrical conductivity in the aligned direction compared to randomly oriented samples, but whereas in the transverse direction, the conductivity was similar to randomly oriented samples.

Accordingly, it would be advantageous to have a composition and method where GNPs were aligned to prevent disadvantages such as agglomeration and to enhance electrical and/or mechanical properties in transverse directions.

### SUMMARY OF THE INVENTION

This disclosure provides a method for planar alignment of graphene nanoplatelets in a plastic matrix, typically a thermosetting based matrix, such as an epoxy matrix. The current state of the art only provides unidirectional alignment along one axis. This disclosure allows for alignment in two axes to achieve planar alignment. This permits control of properties in all three directions.

The alignment of graphene and other nanofillers is of great interest as it provides a mechanism to control the electrical, thermal, and mechanical properties along the alignment axis. The bi-directional (or planar) alignment of graphene, which is the subject of this disclosure, allows for control of alignment in two perpendicular directions and thus the control of electrical, thermal, and mechanical properties in both the alignment directions.

Any solid inclusion suspended in a non-polar liquid experiences a dipole moment due to the applied electric field. The dipole tends to align along the electric field due to its asymmetry in the structure. GNPs have an oblate spheroid with a long axis of around 5 μm and a short axis is around 8 nm, this unique shape allows it to be polarized to form dipoles along any direction perpendicular to its planar axis. Unidirectional alignment (as shown in FIG. 1) can be accomplished by using a stationary electric field which results in the formation of stacked-up chains of GNPs embedded in the plastic matrix. This disclosure focuses on the discovery that bidirectional alignment (as shown in FIG. 2) can be achieved by applying the electric field in two orthogonal directions, and that the electric field cannot be applied simultaneously in both directions as the resultant electric field would again be a unidirectional field. Hence, the discovery that a rotating electric field can be employed so that the migrating charges follow the electric field while the GNP is being aligned along the planar direction.

The processing methods presented here can be extended for any suitable liquid-based plastic system. Especially suitable ones are thermosetting systems, such as an epoxy system. A dispersion of GNPs into the liquid resin can be formed by mechanically blending the GNPs into the liquid resin to get a uniform blend. This liquid mixture is then poured into the electrode setup for alignment.

To this dispersion, a continuous rotating electric field is applied during curing. An alternating electric field can be supplied by an AC signal generator in series with a wideband amplifier. Since GNPs are oblate spheroids, alternating the electric field between consecutive sections provokes unidirectional alignment of particles in perpendicular directions enabling planar alignment of particles in cured resin system. The electric fields will be applied to the perpendicular sections after switching time is achieved, which can be interpreted as unidirectional alignment taking place in two directions. The time required to switch these electric fields is calculated based on the content of GNP in the resin, applied electric field strength, viscosity of the resulting mixture and distance between particles during alignment. After the resin has cured, the GNPs orientation within the epoxy system is preserved.

### BRIEF DESCRIPTION OF THE DRAWINGS

The drawings included in this disclosure illustrate certain aspects of the embodiments described herein. However, the drawings should not be viewed as exclusive embodiments. The subject matter disclosed herein is capable of considerable modifications, alterations, combinations, and equivalents in form and function, as well as be evident to those skilled in the art with the benefit of this disclosure.

FIG. 1 is a schematic illustration of unidirectional alignment of graphene nanoplatelets.

FIG. 2 is a schematic illustration of bidirectional alignment of graphene nanoplatelets.

FIG. 3 is an illustration of one example of platelet-shaped sheets of graphene, which form a graphene nanoplatelet.

FIG. 4 is a schematic illustration of a system suitable for achieving bidirectional alignment of graphene nanoplatelets.

FIG. 5 illustrates the variation of AC Conductivity for planar alignment of M5 GNPs.

FIG. 6 illustrates the variation of AC Conductivity for planar alignment of M25 GNPs.

FIGS. 7-13 illustrate the XRD analysis of planar aligned samples of different concentrations of GNPs for M5 GNPs (FIGS. 7-10) and M25 GNP (FIGS. 11-13).

FIGS. 14-20 show the variations of dielectric constant for three directions of planar aligned samples for weight fractions of M5 GNPs and M25 GNPS.

### DETAILED DISCLOSURE

The present disclosure may be understood more readily by reference to this description as well as to the examples included herein. In addition, numerous specific details are set forth in order to provide a thorough understanding of the embodiments and examples described herein. However, those of ordinary skill in the art will understand the embodiments and examples described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale, and the proportions of certain parts may have been exaggerated to better illustrate details and features of the present disclosure.

As used herein and in the appended claims, an element or component that “comprises” or “includes” one or more specified components or steps means that the element or component includes the specified component(s) alone or includes the specified component(s) together with one or more additional components. An element or component that “consists of” one or more specified components means that the element or component includes only the specified component(s). An element or component that “consists essentially of” one or more specified components means that the element or component consists of the specified component(s) alone, or consists of the specified component(s) together with one or more additional components that do not materially affect the basic properties of the element or component. Whenever a range is disclosed herein, the range includes independently and separately every member of the range extending between any two numbers enumerated within the range. Furthermore, the lowest and highest numbers of any range shall be understood to be included within the range set forth.

### Definitions

As used herein, the following terms have the following meanings.

As used herein, “Graphene” is a super-thin material of carbon atoms arranged in a honeycomb pattern. Carbon has several allotropes, which can be classified according to the type of chemical bond related with hybridization (sp, sp², sp³): zero-dimensional sp² fullerenes, the two-dimensional sp² honeycomb lattice of graphene, or three-dimensional sp³ crystals-diamond. Each allotrope has different electronic and mechanical properties.

Graphene is an allotrope of carbon consisting of a single layer of atoms arranged as two-dimensional material consisting of a single layer of carbon atoms bonded together in a hexagonal, honeycomb-like structure. Carbon atoms are bonded with a covalent sp² bond with a single free electron, which accounts for the conductivity of graphene. Graphene has exceptional physical properties, including extremely high thermal conductivity, excellent electrical conductivity, high surface-to-volume ratio, remarkable mechanical strength, and biocompatibility. Experimental results show that graphene has a remarkably high electron mobility at room temperature and has been considered as an alternative in transistor circuitry. The electron mobility in graphene is almost 200 times higher than Si and 4 times larger than III-V semiconductors. This would make graphene a very attractive material for high-speed transistors.

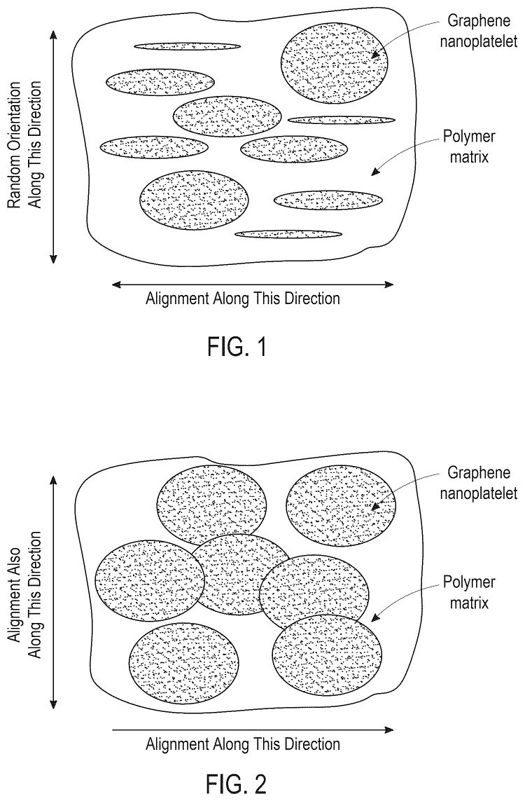

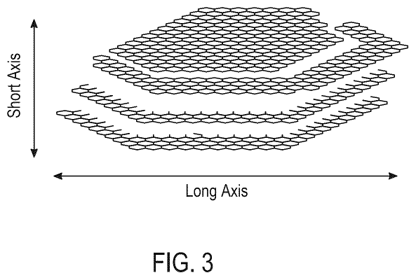

As used herein, “Graphene nanoplatelets” or “GNPs” are tiny, flat pieces of several graphene layers. Graphene nanoplatelets are, very simply, platelet-shaped sheets of graphene stacked on top of one another, as illustrated in FIG. 1. Graphene nanoplatelets are oblate spheroids having a long axis and short axis. They possess many of the same properties as graphene—albeit on a lower scale—but their barrier properties are better. This means that graphene nanoplatelets can easily be dispersed into other existing materials, which is something plain graphene can't do. GNPs have unique properties that make them useful for electronics, batteries, and strong materials.

Typically, the long axis is from 500 nm to 50 μm and the short axis is from 1 nm to 10 nm. However, the long axis can be at least 500 nm, at least 1 μm, or at least 2 μm or at least 5 μm, and can be up to 50 μm, up to 25 μm, or up to 25 μm. For example, the long axis can be in the range of from 1 μm to 50 μm, from 2 μm to 25 μm, or from 5 μm to 25 μm. For example, the long axis can be about 5 μm or can be about 25 μm. The short axis can be at least 1 nm, at least 2 nm, or at least 5 nm, and can be up to 10 nm, or up to 8 nm. For example, the short axis can be in the range of from 2 nm to 10 nm, or from 5 nm to 10 nm, or from 5 nm to 8 nm. For example, the long axis can be about 25 μm and the short axis can be about 6 nm to about 8 nm.

Herein the short axis direction will be sometimes referred to as the thickness direction, through-thickness direction, out-of-plane direction, or z-direction because it is across the layers of graphene as indicated in FIG. 1. The orthogonal directions to the short axis will sometimes be referred to as the in-plane direction, plane direction, or planar direction, or when referring to two orthogonal directions within the plane, the x and y directions. In some cases, the numbers 1, 2, and 3 will be used for the directions instead of x, y, and z, respectively.

### EMBODIMENTS

This disclosure and embodiments are directed at compositions and methods of producing compositions having nanoplatelets aligned in the planar directions. In other words, the compositions are comprised of graphene nanoplatelets in a matrix material wherein the graphene nanoplatelets have alignment within the matrix material in two orthogonal directions to result in planar alignment. In the composition of the graphene nanoplatelet, the planar alignment is such that the long axis of the nanoplatelets align along two orthogonal directions of the matrix material with the short axis being aligned along a third orthogonal direction of the matrix material. Generally, the composition is produced so as to avoid the formation of conductive chains of graphene nanoplatelets in the two orthogonal directions; thus, they can be advantageously free or nearly free of such conductive chains.

The matrix material can generally be a polymer such as a thermosetting polymer or thermoplastic polymer. However, typically the matrix material will be a thermosetting polymer. For example, the matrix material can be an epoxy. The matrix material will generally be one that has a liquid precursor, such as a thermosetting resin (for example an epoxy resin), which cures to the matrix material such as by use of a co-reactant-often called a curing agent or hardener. For example, the epoxy can be one derived from a difunctional bisphenol A/epichlorohydrin derived liquid epoxy resin (such as EPON™ resin 828 marketed by Westlake Inc.). The graphene nanoplatelets can be present in an amount from 0.1 wt % to 5.0 wt % based on the total composition, or alternatively based on the GNPs & matrix material components, or optionally from 0.17 wt % or 0.3 or 0.5 wt % up to 4 wt %, or 3 wt %, or 2 wt % or 1.5 wt %.

The composition can be produced by a method of aligning graphene nanoplatelets in the matrix material. For example, some embodiments involve forming a dispersion of GNPs and aligning them by use of an electric field while the liquid precursor hardens into the matrix material.

In such embodiments, a dispersion can be formed by dispersing the graphene nanoplatelets in the liquid precursor of the matrix material. For example, the graphene nanoplatelets can dispersed by mechanically blending the graphene nanoplatelets into the liquid precursor to get a uniform blend.

Subsequently, the liquid precursor is cured or hardened to form the matrix material. During the curing or hardening, an electric field is applied to the dispersion to align the GNPs. Generally, the electric field will be an alternating current electric field. The electric field is applied in two orthogonal directions. After the plastic resin has cured, the GNPs orientation will be preserved.

Any solid inclusion suspended in a non-polar liquid experiences a dipole moment due to the applied electric field. The dipole tends to align along the electric field due to its asymmetry in the structure. Here, GNPs have an oblate spheroid with a long axis on the order of 500 nm to 50 μm and a short axis around 1 to 10 nm, this unique shape allows it to be polarized to form dipoles along its planar direction.

For the bidirectional alignment—or planar alignment, the electric field must be applied in two orthogonal directions. In this case, the electric field cannot be applied simultaneously in both directions as the resultant electric field would be a unidirectional field—similar to if the electric field was applied in only a single direction. Hence, a rotating electric field is employed in this invention so that the migrating charges follow the electric field while the GNPs are being aligned along the planar direction. Generally, the rotating electrical field will switch between one of the planar directions to the other planar direction multiple times during the curing of the matrix material. For example, the switching time may be 1/10 to 1/5000 of the curing time or can be from 1/20 to 1/2000 of the curing time, or can be from 1/50 to 1/1500 of the curing time. Thus, the switching time can be measured in seconds and the curing time in minutes. For example, the switching time can be from 0.25 sec to 200 sec, or from 0.5 sec to 150 sec, or from 1 sec to 100 sec, and the curing time can be from 30 min to 2 hours, or from 40 min to 1.5 hours, or from 50 min to 80 min.

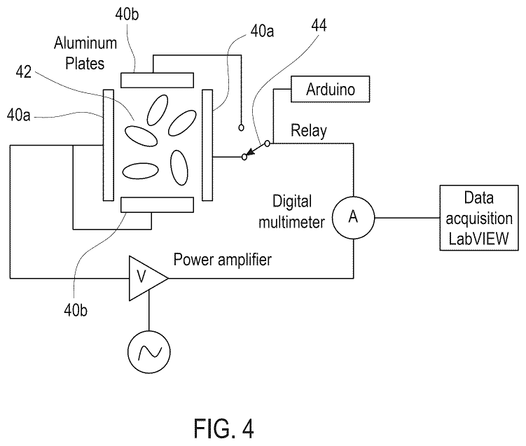

For example, the dispersion can be introduced into a mold having a plurality of electrode plates configured to surround the dispersion on four sides. A schematic illustration of such a system is shown in FIG. 4, wherein sets pairs of electroplates, plates 40a and plates 40b, surround a dispersion 42 of GNPs in a liquid matrix-material precursor. Rotation of the electric field between plates 40a and 40b is by switch 44, which is controlled by the other illustrated electronics.

Accordingly, to produce a composition comprising planar-aligned graphene nanoplatelets in the matrix material, the electric field is rotated so as not to be applied simultaneously in both directions. For example, the electric field can be rotated such that it is switched between being aligned across the dispersion in a first orthogonal direction (such as between plates 40a) and a second orthogonal direction (such as between plates 40b). The electric field typically is switched from the first orthogonal direction to the second orthogonal direction prior to translation of the graphene nanoplatelets which would cause chain formation in in the first orthogonal direction, and switched from the second orthogonal direction to the first orthogonal direction prior to translation of the graphene nanoplatelets which would cause chain formation in the second orthogonal direction. For example, the electric field can be switched in an amount of time from 25% to 75% of the amount of time for translation of the graphene nanoplatelets in the dispersion, and optionally from 40% to 60%, or about 50% of the amount of time for translation. By using such a technique, the produced composition comprises graphene nanoplatelets that have alignment within the matrix material in two orthogonal directions to result in the planar alignment. In this manner, the graphene nanoplatelets are oblate spheroids are oriented such that the long axis of the graphene nanoplatelets aligns along the first and second orthogonal directions with the short axis being aligned along a third orthogonal direction of the matrix material (perpendicular to the plane of FIG. 4).

### EXAMPLES

The following example illustrates specific embodiments consistent with the present disclosure but does not limit the scope of the disclosure or the appended claims. Concentrations and percentages are by weight unless otherwise indicated.

Experiments were conducted for two different types of GNPs (M5 and M25) whose diameters are 5 μm and 25 μm respectively. The concentrations of these GNPs varied from 0.175 to 1.4 wt %. Validation of the planar alignment was done by AC conductivity measurements and dielectric spectroscopy. The fracture surfaces of planar aligned GNP composites were viewed under a scanning electron microscope (SEM). Furthermore, XRD analysis was used to evaluate the anisotropy in the final GNP composite.

In the Examples, various concentrations (0.175-1.4 wt %) of GNPs of two sizes (M-5 and M-25) were aligned along the in-plane directions (x and y) using a rotating electric field in a thermosetting epoxy. In-situ AC conductivity measurements were used to characterize the alignment process. Dielectric constants of the resultant composite were calculated for in-plane and through-thickness directions to substantiate the planar alignment.

For planar alignment, the electrode manufacturing used an aluminum pipe of diameter 9 mm and length 150 mm, which was filled with molding wax. Four horizontal and equally spaced groves were cut at 90 degrees along the length of the pipe using a milling machine. Around 25 mm of pipe was left unmachined on each side to provide structural support, which was sawed off later. Smaller groove width and accurately spaced grooves were used for uniform alignment. The groove width was around 1.5 mm. Then fast casting epoxy (JB clear weld epoxy) was applied between the grooves to provide structural support by adhering the electrode sections and insulating the adjacent aluminum sections. After curing for 24 hours at room temperature, the setup was placed in an oven at 60° C. to melt the molding wax and subsequently, the unmachined part of the aluminum pipe was sawed off manually. The result is a composite pipe consisting of equally spaced conductive aluminum sections separated by 1.5 mm insulating epoxy sections. The bottom part of the composite pipe electrode was filled with silicone mold-making epoxy to prevent leakage of the epoxy/GNP mixture during the process of alignment.

To provide a continuous rotating electric field to the epoxy through the conducting aluminum sections, an electrode holding setup was 3D printed using PLA which can hold the electrode and simultaneously rotate using a stepper motor controlled by Arduino software. The composite pipe was mounted on the electrode holder. Two spring-loaded electrodes were employed to ensure a good connection to the aluminum electrodes while rotating and to create an electric field between the parallel composite pipe aluminum sections. The stepper motor rotated the composite pipe so that the two parallel sections created an electric field alternatively.

Observing and quantifying the alignment process using AC current was done using a multi-meter connected in series with the wide-band amplifier (7602 M. Krohn-Hite Corporation, Brockton, Massachusetts), which was connected in series with the spring-loaded electrodes and the composite pipe. The data acquisition of AC current variations was made in LABVIEW to observe the real time alignment process.

For the Examples, the GNPs (M5 and M25, XG Sciences, Lansing, Michigan) had an average thickness of 6-8 nm with a surface area of 120-150 m2/g and an average particle diameter of 5 and 25 μm respectively. Epoxy resin (EPON 862, Hexion, Columbus, Ohio) and hardener (EPIKURE Curing agent 3274, Hexion, Columbus, Ohio) were used for dispersing the GNPs. EPON 862 is a low viscosity blend of diglycidyl ether of bisphenol F. The liquid hardener was a moderately reactive low viscosity aliphatic amine.

GNPs in powder form were added to epoxy resin and stirred on a magnetic stirrer for an hour to dissolve and break the larger agglomerates. Then the mixture was passed through a three-roll mill (T65, Torrey Hills Technologies, San Diego, California) for 15 times at 100 rpm with a roller-gap distance of 25 μm to exfoliate and obtain uniform dispersion of GNPs in epoxy. After the dispersion process, a stoichiometric ratio of hardener (100:40) was added to the mixture and degassed in a vacuum oven for 30 min to remove the trapped air bubbles. The mixture was then poured into a mold made of aluminum plates for unidirectional alignment and an aluminum composite pipe electrode for planar alignment (as illustrated in FIG. 4). The samples were cured at room temperature for 24 hours prior to electrical testing.

Nanocomposites of different weight fractions (0.175, 0.35, 0.7, and 1.4 wt %) of size M5 and weight fractions (0.175, 0.35, 0.7 wt %) of size M25 were used for planar alignment. These samples were aligned at 25 V/mm and 10 KHz.

The dynamic viscosity of the GNP and the epoxy mixture was measured prior to the alignment process using a viscometer (LVDVE, Brookfield, Middleboro, Massachusetts) according to ASTM-D2196. Post alignment and curing, 5 samples of size 5×5×2 mm were cut from 90-degree orientations which resemble 1 and 2 directions, and specimens of size 5×5×2 mm were cut cross-sectionally along the z-axis which resembles direction 3. Due to the presence of insulating epoxy, the top and bottom surfaces were coated with an electrically conductive epoxy (Duralco 120, Cotronics, Brooklyn, New York) to provide uniform electrical contact.

XRD was performed for each weight concentration of both M5 and M25 planar aligned GNPs in three directions (x, y, z). XRD analysis was done using AXS D8 Discover diffractometer (Bruker, Madison, Wisconsin) with a Cu-ka (40 kV, 40 mA) X-ray source. The XRD data was collected over a 20 range of 10 to 50 degrees using a refractive mode 2-D detector. The pixel overlap was 30% and each frame was exposed to 30 seconds.

The cylindrical samples were fractured using liquid nitrogen to visually observe the planar aligned GNPs. The surfaces were fractured in two orthogonal directions and the in-plane and out of plane surfaces were viewed under a field emission scanning electron microscope (S-4800 FESEM, Chiyoda City, Tokyo). The surfaces were coated with iridium han using a sputter coater (EM ACE600, Leica Microsystems Inc., Deerfield, Illinois).

The dielectric spectroscopy was performed to obtain the dielectric constant and dielectric loss along the aligned direction using a potentiostat (VersaSTAT 3F, Ametek, Berwyn, Pennsylvania). For these properties, the frequency ranged from 1 Hz to 1 MHz. In all characterization tests, randomly oriented samples were compared to aligned samples. Dielectric constant, dielectric loss, and AC conductivity were calculated using standard formulations as follows.

$${ε}_{r}^{′} = \frac{- {Z}^{″}}{2 π f {ε}_{o} ( {( {Z}^{′} )}^{2} + {( {Z}^{″} )}^{2} )} \frac{l}{A}$$

$${ε}_{r}^{″} = \frac{{Z}^{′}}{2 π f {ε}_{o} ( {( {Z}^{′} )}^{2} + {( {Z}^{″} )}^{2} )} \frac{l}{A}$$

$${σ}_{AC} = 2 π f {ε}_{o} {ε}_{r}^{″}$$

Here, f is the AC frequency, εₒ is the permittivity of free space, I and A are sample thickness and surface area respectively and Z′ and Z″ are the real and imaginary parts of impedance, respectively.

A single GNP surrounded by a dielectric fluid will undergo electronic polarization in the presence of an external electric field. The polarization is higher in the in-plane direction compared to the through thickness direction causing a dipole effect. This dipole is typically unaligned in the electric field, and it produces a dipole moment at the center of the platelet which causes it to rotate towards the electric field while opposing the rotational viscous force generated by the epoxy. After they are aligned in the fluid, the presence of attraction forces from nearby particles causes a translation motion that results in long chains of particles. This translation force is opposed by the translational viscous force. Depending on the electric field strength, particle size, viscosity of the fluid rotation and translation times vary. The rotation time of a GNP experiencing an external electric field (Eₒ) has been formulated from an initial angle θₒ to a final angle θ′. This is given by the following equation.

$${t}_{r} = \frac{1}{A} ln \frac{tan {θ}_{o}}{tan {θ}^{′}}$$

$$A = \frac{π}{8 η} \frac{{ε}_{m}}{( \frac{π}{2} - \frac{b}{a} )} {E}_{o}^{2}$$

Here, A is a function of the viscosity of the epoxy (η), dielectric constant of the epoxy (εₘ), electric field strength (Eₒ), half thickness of GNP (b) and radius (a).

Subsequently, the particles tend to translate after they are aligned towards the electric field. The translation time is given by the following equation.

$${t}_{c} = \frac{2 {x}_{o}^{3}}{3 B}$$

$$B = \frac{4 π {a}^{4}}{9 η {k}_{t} {ε}_{o}} \frac{{E}_{o}^{2} {ε}_{m}^{2}}{{( \frac{π}{2} - \frac{b}{a} )}^{2}}$$

$${x}_{o} = \frac{1}{ρ} \frac{{m}_{G}}{{W}_{G}} \frac{1}{4 {a}^{2}}$$

Here, t_{c} is the translation time of the particles, kₜ is the translational friction coefficient that depends on the surface area of GNP and xₒ is the initial perpendicular distance between two adjacent particles which depends on the density of the epoxy (φ, weight fraction of GNP (W_{G}), mass of GNP (m_{G}) and radius of GNP (a). The mass of GNP (m_{G}) is calculated to be around 2.65×10⁻¹⁴ kg for an M25 GNP particle. The radius of the platelet is 12.5 μm. The density of the epoxy system (1.1 g/cm³) was calculated from the densities of the epoxy and hardener. Also, B is a constant depending on the viscosity, dimensions of the platelet, dielectric constant of the epoxy and the intensity of the electric field.

The above-mentioned equations gave an approximate time for alignment, taking into account that the viscosity would remain low for the addition of lower-weight fractions. Higher-weight fractions of GNPs will lead to a drastic increase of viscosity subsequently increasing the particle-to-particle interactions. A study on polarization forces and conductivity effects in electrorheological fluids showed that multiple particle interactions should be considered if the distance between particles is less than the particle diameter. Based on the above theories, no added viscosity effects were considered for samples whose interparticle distance is more than the diameter. In other cases, the viscosity was considered to be an additional factor in deciding the translational time and rotational time. Tables 1 and 2 show the variation of calculated rotation and translation times of different GNPs size and their concentrations.

TABLE 1
M5 GNP

| | xₒ | Rotation time | Translation time |
|---|---|---|---|
| GNP wt % | (μm) | (min) | (sec) |
| 0.175 | 22 | 20 | 7273 |
| 0.35 | 11 | 20 | 910 |
| 0.7 | 5.5 | 20 | 114 |
| 1.4 | 2.8 | 22 | 16 |

TABLE 2
M25 GNP

| | xₒ | Rotation time | Translation time |
|---|---|---|---|
| GNP wt % | (μm) | (min) | (sec) |
| 0.175 | 21 | 20 | 34 |
| 0.35 | 11 | 22 | 4.7 |
| 0.7 | 5.5 | 24 | 0.8 |

If the viscosity is assumed to be the same, the particle rotation time does not change, which is true for M5 (0.175, 0.35 and 0.7 wt %) and M25 (0.175 wt %). Whereas in other cases, the particle distance is less than the particle diameter, hence there is a slight increase in rotation time. Although the increase seems insignificant, as the weight fraction of GNP increases, we saw noticeable changes in rotation and translation times that should be accounted for planar alignment. It was assumed that the translation of particles takes place after rotation and dispersion is uniform throughout. However, if the particles are close to each other, translation can take place irrespective of its orientation. This is an important consideration for planar alignment, where we defined switching time. Translation takes place due to opposite charges present on the nearby particles, and when the electric field rotates 90°, the charges on the transversely isotropic platelets switch accordingly. This causes repulsion of the nearby particles and may disorient the particles. Hence, to avoid chain formation the electric field needs to be rotated before the complete translation of the particles takes place. Hence, the switching time was considered to be around 0.5 times the translation time. This ensured that the particles rotated uniformly in both the x and y directions. However, for lower weight fractions in the case of M5 (0.175 wt %), the switching time is very high compared to the rotation time. Here, any arbitrary switching time can be considered provided it is equally distributed between the x and y directions.

The calculated rotation and switching time for M5 and M25 GNPs exposed to 25 V/mm 10 kHz electric field is shown in Table 3. Switching time was defined as the time after which the electric field was rotated 90° about the z-axis.

TABLE 3

| | |
|---|---|
| M5 | M25 |

| | Rotation | Switching | Rotation | Switching |
|---|---|---|---|---|
| GNP | time | time | time | time |
| wt % | (min) | (sec) | (min) | (sec) |
| 0.175 | 50 | 6747 | 50 | 43 |
| 0.35 | 50 | 843 | 52 | 10 |
| 0.7 | 50 | 105 | 56 | 1 |
| 1.4 | 54 | 14 | — | — |

### AC Conductivity.

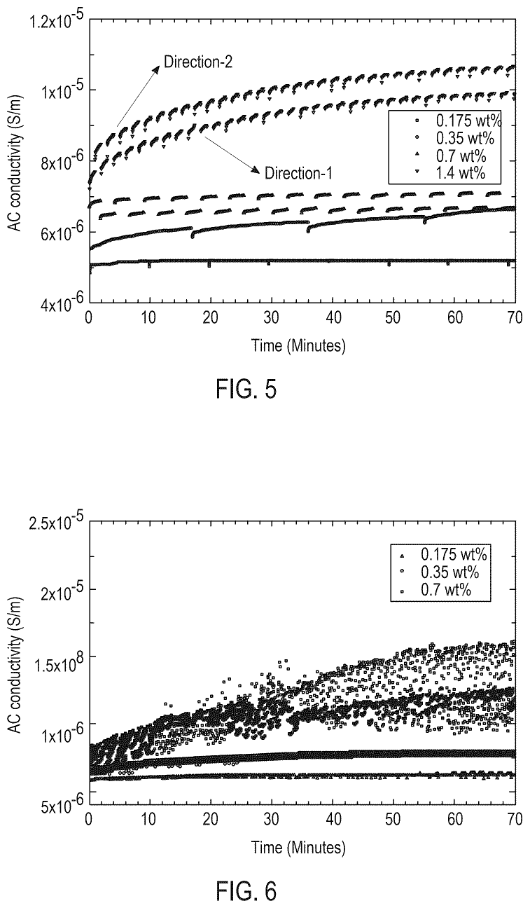

The change in orientation of the GNP and chain formation was monitored by AC current flowing through the system. Due to the vast difference in electrical conductivity of the graphene nanoplatelet along in-plane and perpendicular to the plane, an increase in AC current was evident as the particle is aligning along the electrical field. FIG. 5 shows the variation of AC conductivity for the planar alignment of M5 GNPs. Here, each curve for a specific concentration represents AC conductivity in two perpendicular in-plane directions. Thus, FIG. 5 shows the increment in AC current in direction-x, then the system rotated 90° which caused the electrical field to be perpendicular to its initial position. This took place when switching time was reached, and the corresponding increment in AC current in direction-y is shown after the initial increment in direction-x. This rotation and simultaneously acquiring data continued to take place until planar alignment was achieved. The slight difference in the magnitude of AC conductivity between both directions was attributed to the minor machining errors of the composite electrodes causing a slight difference in electric fields. Further, FIG. 6 shows the variation of AC conductivity for planar alignment of M25 GNPs. Here, each curve for a specific concentration represents AC conductivity in two perpendicular in-plane directions.

For each concentration represented in FIGS. 5 and 6, two curves represent the AC conductivity in direction-1 and direction-2. It should be emphasized that alignment taking place in direction-1 has negligible influence on direction-2. This can be substantiated by observing the discontinuities of AC conductivity for M5-15-1.4 wt % in directions 1 or 2. If the alignment in direction-1 was affecting direction-2, a larger discontinuity between would be noticed between subsequent alignment curves. For M5-1.4 wt % the switching time was around 60 seconds. The AC conductivity was first measured in direction-1 and after 60 seconds, the electric field was rotated 90° about direction-3 and AC conductivity was measured in direction-2 for 60 seconds. This repeated for 70 minutes. Hence, for this concentration, there were 35 smaller curves for each direction which resembles the change in orientation of the GNPs. A similar increase in conductivity over time was seen, which signified uniform alignment taking place in both directions. It should be noted that the slight difference between the direction-1 and direction-2 curves was due to geometric error during the manufacturing of the electrodes. M5-1.4 wt % showed the highest increment of conductivity over time, due to close proximity and higher number of particles.

Similar behavior was noticed for planar aligned M25 GNP composites as shown in FIG. 6. M25-0.7 wt % experienced a larger increase in conductivity compared to 0.175 and 0.35 wt % due to the possibility of electron hopping apart from other mechanisms of conductance as mentioned in the previous passage. The electric field switching time for M25-0.7 wt % was 1 second, and the AC conductivity data of the two directions showed a slight deviation which could imply faster rotation of electric fields is necessary. When the switching time is so low, the rotation speed of the motor which ultimately defines the rotation of the electric field should be taken into consideration. For concentrations of 0.175 and 0.35 wt %, we see a noticeable increase in AC conductivity for the first 5 minutes and 20 minutes, respectively, and stabilizes thereafter. Nonetheless, the small increments can be associated with orientation changes in GNPs and based on the AC conductivity curves, uniform alignment was taking place.

### XRD.

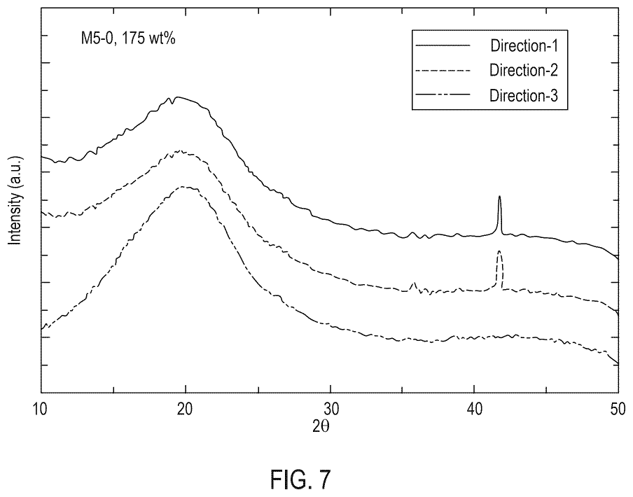

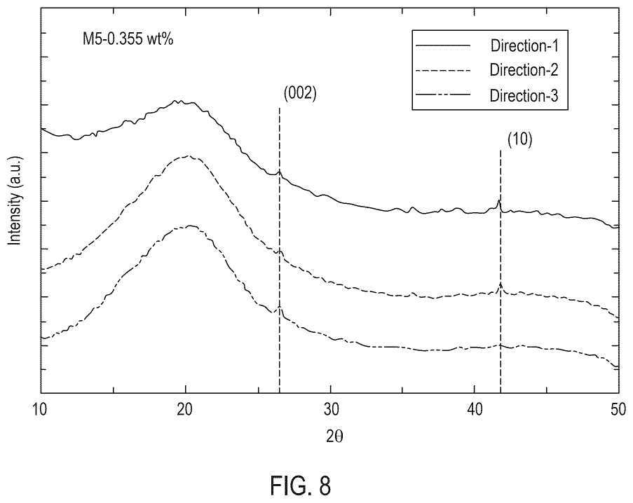

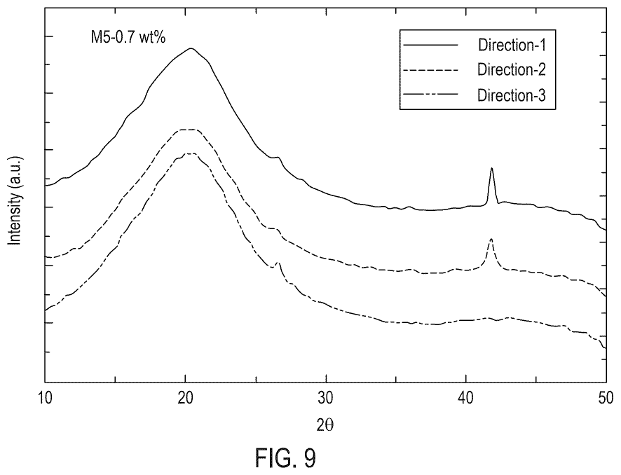

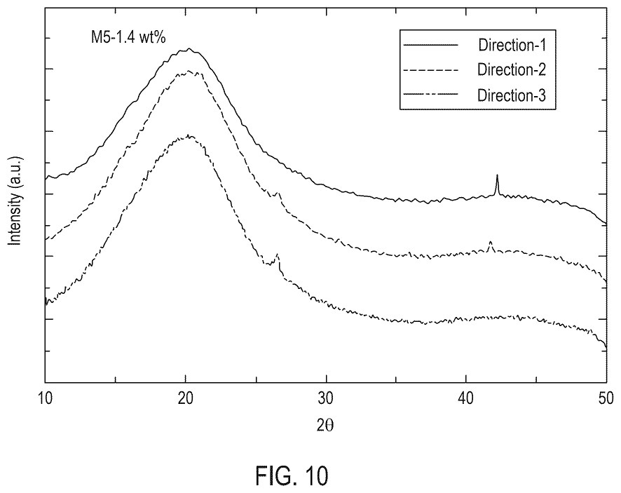

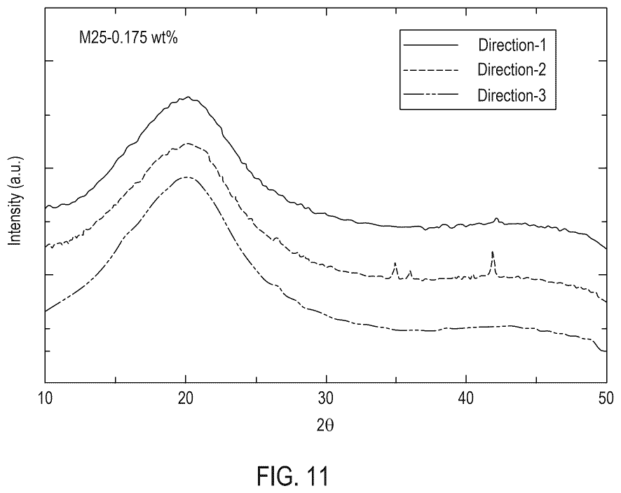

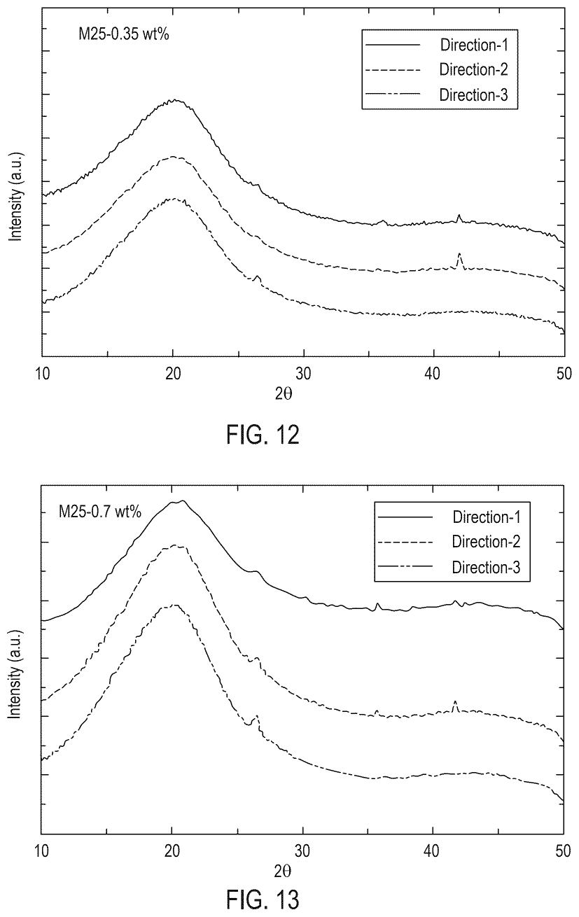

To further validate the planar alignment, XRD analysis of planar aligned samples was performed for the three orthogonal directions for all the concentrations of GNPs. FIGS. 7-13 show the XRD patterns for M5 GNPs (FIGS. 7-10) and for M25 GNPs (FIGS. 11-13).

The XRD patterns obtained for planar aligned samples for a 2θ range of 10° to 50° for M5 and M25 GNPs of different concentrations are shown. Directions 1 and 2 refer to in-plane directions, and direction-3 refers to the through-thickness direction. In all the samples, we saw the broad amorphous region exhibited by epoxy. The XRD spectra also shows (002) diffraction peak at 20=26.5°, indicating the distance between graphene layers. The application of Bragg's equation gives rise to d-spacing of 3.35 nm, which is the typical distance between graphene layers. The (10) diffraction peak indicated a d-spacing of 0.21 nm according to Bragg's equation and this corresponds to the short-range order of stacked graphene sheets. In all the XRD spectra, direction-3 did not have the (10) peak, and (002) peak was more prominent compared to other directions. However, directions 1 and 2 contained the (10) peak which is only captured when the graphene layers are aligned perpendicular to the incident X-rays. The consistency of this peak in all the samples for in-plane directions provided additional validation of planar alignment transpiring.

### Dielectric Properties

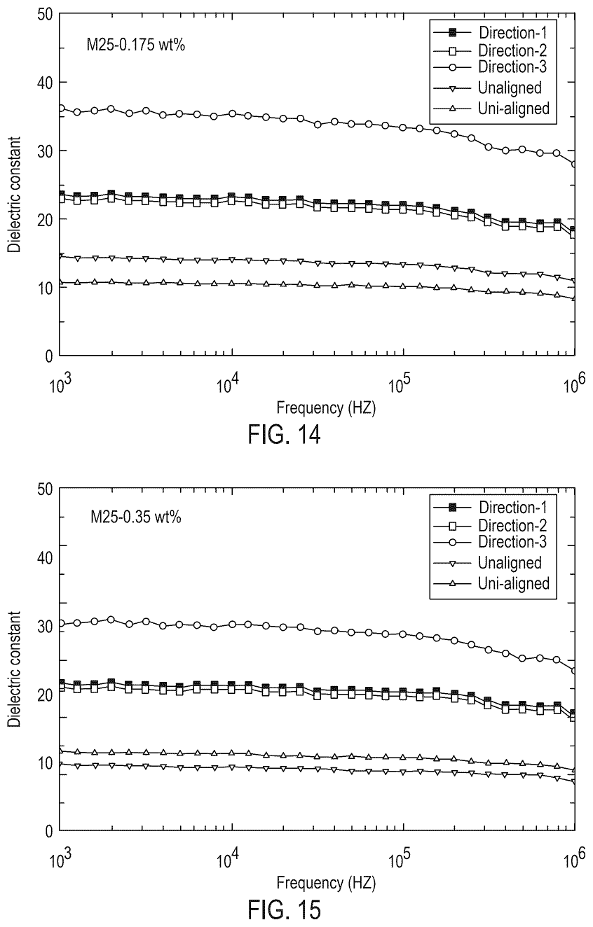

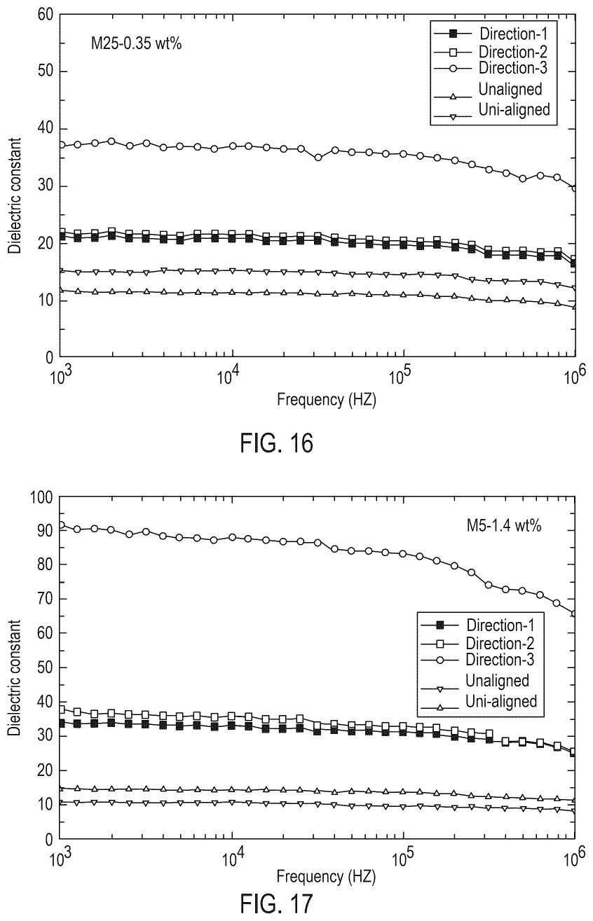

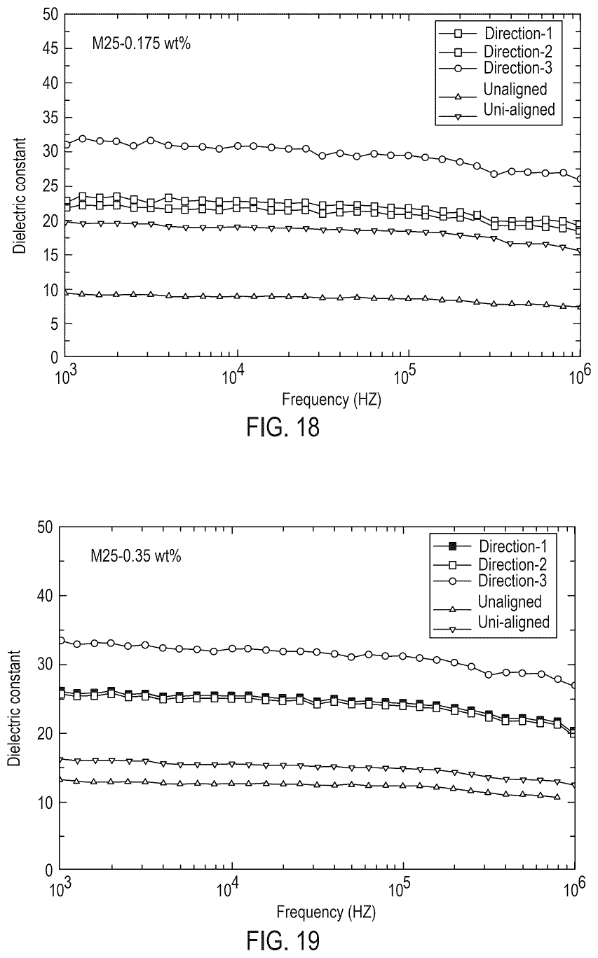

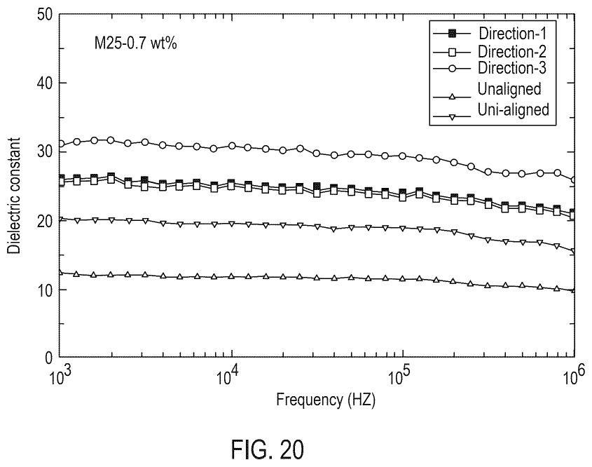

To analyze these samples, dielectric spectroscopy was performed on a potentiostat (VersaSTAT 3F, Ametek, Berwyn, Pennsylvania) for three directions of the planar aligned samples, aligned direction of unidirectionally aligned samples and unaligned samples. Small samples of size 3×4×5 mm were cut using a precision saw (Isomet 500, Buehler, Lake Bluff, Illinois) and silver epoxy (Duralco 120, Cotronics, Brooklyn, New York) was applied on the surfaces to ensure uniform electrical contact. The dielectric constant was calculated for a frequency range (103 to 106 Hz) using standard formulations. FIGS. 14-20 shows the variation of dielectric constant for three directions of planar aligned samples for three weight fractions of GNPs in epoxy. Also, FIGS. 14-20 show dielectric constant dependence on frequency for unaligned and unidirectionally aligned M5 and M25 for various concentrations, in addition to the planar aligned samples of this Example.

For all the weight fractions, an increment in dielectric constant in all three directions was observed when compared to unaligned samples. The dielectric constant variation for different weight fractions in directions 1 and 2 were the same, this suggests that planar alignment was achieved for all the concentrations tested. Dielectric constant increases when the inter particle distance reduces during alignment which forms a micro capacitor. Unidirectional samples tend to form long chains which can lead to agglomeration of particles; hence the dielectric constant is relatively less compared to the orderly fashion exhibited by planar aligned particles. In all cases, direction-3 showed a significantly improved dielectric constant due to the formation of uniformly spaced micro capacitors and the contribution of the increased surface area from the oblate spheroid shape of the GNPs. There are two reasons for this, the dielectric constant of graphene is 1.67 times higher along the perpendicular direction compared to the planar direction and due to the oblate spheroid shape of these particles, the surface area for charge accumulation is much more on the planar side of these particles. In all cases, the dielectric constant decreased as frequency increased due to the increased energy leading to electron hopping. Also, the significant increase in dielectric constant for planar aligned 1.4 wt % GNPs in epoxy when compared to 0.35 wt % and 0.7 wt % can be attributed to the achievement of percolation threshold resulting in the system becoming more conductive.

The planar aligned samples showed consistent behavior for all three directions tested. The dielectric constant in direction-1 and direction-2 was equal. Due to the transversely isotropic nature of GNP, this was an expected behavior and confirms the in-plane isotropy of the sample. Compared to unidirectionally aligned samples, planar aligned samples had a higher dielectric constant along the in-plane direction. This can be explained by the increased availability of particles to enhance the mini capacitor effect and planar orientation which utilizes the maximum directional effects. In unidirectional alignment, the GNPs tend to form agglomerated chains which render ineffective regions that do not contribute to the dielectric constant. The mechanism of the planar alignment process prevents agglomerations due to the constant attraction and repulsion of adjacent particles. Nevertheless, the dielectric constant in direction-3 was relatively higher than in-plane dielectric constants (directions 1 and 2) for all concentrations. This confirmed that planar alignment has materialized for both M5 and M25 GNPs.

### Fractographic Analysis

Additionally, samples were fractured under liquid nitrogen conditions in two different orthogonal planes i.e., along the plane and perpendicular to the plane. Different surface morphologies were obtained depending on the plane of fracture. The images obtained showed that the planar alignment of GNPs had transpired.

The above examples substantiate that the methods of this disclosure successfully aligned transversely isotropic GNPs along the in-plane directions using a rotating electric field. The rotation speed of the electric field was dependent on electric field strength, and on the concentration and size of GNPs. Two different sizes, M5 and M25, of different concentrations i.e., 0.175, 0.35, 0.7 and 1.4 wt % were aligned along the planar direction. The alignment of GNPs was initially characterized by the AC current flowing the system in two perpendicular in-plane directions. The systematic and periodic increase of AC conductivity showed that alignment along these directions was taking place uniformly. XRD analysis of these cured samples along the three orthogonal directions identified the graphene and lattice constant of graphene. The interlaminar distance peak was more pronounced in the through-thickness XRD analysis. The two in-plane XRD patterns were comparable, and they featured the peak that captures the lattice constant of graphene, and this can only be recognizable in the in-plane direction, thus signifying the planar orientation of GNPs. In addition to this, dielectric spectroscopy of the planar aligned samples in three orthogonal directions showed the indistinguishable pattern of dielectric constant variation along the two in-plane directions with frequency for each concentration. The dielectric constants of planar aligned samples were compared with unaligned and unidirectionally aligned samples. Planar aligned samples demonstrated higher dielectric constants due to the availability of GNPs, lack of conduction pathways and uniform distribution of oriented GNPs. Fracture surfaces viewed under an SEM further provided proof of the planar orientation of GNPs and showed the different surface morphologies obtained by fracturing in two perpendicular orientations. The planar aligned GNP samples can also exhibit anisotropic fracture toughness.

The method and compositions of this disclosure can be further understood by the following numbered embodiments.

Embodiment 1: A method of aligning graphene nanoplatelets in a matrix material, the method comprising:
dispersing the graphene nanoplatelets in a liquid precursor to produce a dispersion;
curing the dispersion, wherein the liquid precursor cures to form the matrix material; and
while curing, applying an electric field to the dispersion in two orthogonal directions so as to produce a composition comprising planar-aligned graphene nanoplatelets in the matrix material, wherein the electric field is rotated so as not to be applied simultaneously in both directions.

Embodiment 2: The method of Embodiment 1, where the matrix material is a thermosetting plastic and the liquid precursor is a liquid-based thermosetting resin, and optionally where the matrix material is an epoxy, and the liquid precursor is a liquid-based epoxy resin.

Embodiment 3: The method of either Embodiment 1 or Embodiment, wherein step of dispersing the graphene nanoplatelets in the liquid precursor is carried out by mechanically blending the graphene nanoplatelets into the liquid precursor to get a uniform blend.

Embodiment 4: The method of any of Embodiments 1 to 3, further comprising introducing the dispersion into a mold having a plurality of electrode plates configured to surround the dispersion on four sides.

Embodiment 5: The method of any of Embodiments 1 to 4, wherein the electric field is rotated such that it is switched between being aligned across the dispersion in a first orthogonal direction and in a second orthogonal direction and wherein the electric field is switched from the first orthogonal direction to the second orthogonal direction prior to translation of the graphene nanoplatelets which would cause chain formation in the first orthogonal direction, and switched from the second orthogonal direction to the first orthogonal direction prior to translation of the graphene nanoplatelets which would cause chain formation in the second orthogonal direction.

Embodiment 6: The method of Embodiment 5, wherein the electric field is switched in an amount of time from 25% to 75% of an amount of time for translation of the graphene nanoplatelets in the dispersion, and optionally from 40% to 60%, or 50% of the amount of time for translation.

Embodiment 7: The method of any of Embodiments 1 to 6, wherein the produced composition comprises graphene nanoplatelets has alignment within the matrix material in two orthogonal directions to result in the planar alignment.

Embodiment 8: The method of any of Embodiments 1 to 7, wherein the graphene nanoplatelets are oblate spheroids having a long axis and short axis, and the planar alignment is such that the long axis of the nanoplatelets align along the two orthogonal directions with the short axis being aligned along a third orthogonal direction of the matrix material.

Embodiment 9: The method of any of Embodiments 1 to 8, wherein the composition is produced so as to avoid the formation of conductive chains of graphene nanoplatelets in the two orthogonal directions.

Embodiment 10: The method of any of Embodiments 1 to 9, wherein the long axis is from 500 nm to 50 μm and the short axis is from 1 nm to 10 nm, and optionally the long axis is from 1 μm to 50 μm or from 2 μm to 25 μm, or from 5 μm to 25 μm, and optionally the short axis is from 2 nm to 10 nm, or from 5 nm to 10 nm or from 5 nm to 8 nm.

Embodiment 11. The method of any of Embodiments 1 to 10, wherein the graphene nanoplatelets are present in an amount from 0.1 wt % to 5.0 wt % based on the total composition, optionally from 0.17 wt % or 0.3 or 0.5 wt % up to 4 wt %, or 3 wt %, or 2 wt % or 1.5 wt %.

Embodiment 12: A composition resulting from the method of any of Embodiments 1 to 11.

Embodiment 13: A composition comprising graphene nanoplatelets in a matrix material wherein the graphene nanoplatelets have alignment within the matrix material in two orthogonal directions to result in planar alignment.

Embodiment 14: The composition of Embodiment 13, wherein the matrix material is a thermosetting plastic, and optional an epoxy.

Embodiment 15: The composition of Embodiment 14, wherein the graphene nanoplatelets are oblate spheroids having a long axis and short axis, and the planar alignment is such that the long axis of the nanoplatelets aligned along the two orthogonal directions with the short axis being aligned along a third orthogonal direction of the matrix material.

Embodiment 16: The composition of any of Embodiments 13 to 15, wherein the composition is produced so as to avoid the formation of conductive chains of graphene nanoplatelets in the two orthogonal directions.

Embodiment 17: The composition of any of Embodiments 13 to 16, wherein the long axis is from 500 nm to 50 μm and the short axis is from 1 nm to 10 nm, and optionally the long axis is from 1 μm to 50 μm or from 2 μm to 25 μm, or from 5 μm to 25 μm, and optionally the short axis is from 2 nm to 10 nm, or from 5 to 10 nm or from 5 to 8 nm.

Embodiment 18: The composition of any of Embodiments 13 to 17, wherein the graphene nanoplatelets are present in an amount from 0.1 wt % to 5.0 wt % based on the total composition, optionally from 0.17 wt % or 0.3 or 0.5 wt % up to 4 wt %, or 3 wt %, or 2 wt % or 1.5 wt %.

Unlike one direction alignment, planar alignment of GNPs will fully utilize the transversely isotropic properties of GNPs and will yield a uniform array capable of developing tunable nanocomposites. Furthermore, using a rotating electric field generates repulsion of adjacent particles which prevents chain formation that could lead to agglomerated chains.

Planar alignment of GNPs will lead to anisotropic electrical, mechanical and thermal properties in the bulk composite. Of these, the dielectric properties of graphene nanocomposites are of particular interest due to their potential applications such as integrated circuits, electromagnetic shielding, and embedded capacitors.

Therefore, the present compositions and methods are well adapted to attain the ends and advantages mentioned, as well as those inherent therein. The particular examples disclosed above are illustrative only, as the present methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. Every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A method of aligning graphene nanoplatelets in a matrix material, the method comprising:
dispersing the graphene nanoplatelets in a liquid precursor to produce a dispersion;
curing the dispersion, wherein the liquid precursor cures to form the matrix material; and
while curing, applying an electric field to the dispersion in two orthogonal directions so as to produce a composition comprising planar-aligned graphene nanoplatelets in the matrix material, wherein the electric field is rotated so as not to be applied simultaneously in both directions.

2. The method of claim 1, wherein the matrix material is a thermosetting plastic and the liquid precursor is a liquid-based thermosetting resin, and optionally where the matrix material is an epoxy, and the liquid precursor is a liquid-based epoxy resin.

3. The method of claim 2, wherein the step of dispersing the graphene nanoplatelets in the liquid-based thermosetting resin is carried out by mechanically blending the graphene nanoplatelets into the liquid-based thermosetting resin to get a uniform blend.

4. The method of claim 3, further comprising introducing the dispersion into a mold having a plurality of electrode plates configured to surround the dispersion on four sides.

5. The method of claim 1, wherein the electric field is rotated such that it is switched between being aligned across the dispersion in a first orthogonal direction and in a second orthogonal direction and wherein the electric field is switched from the first orthogonal direction to the second orthogonal direction prior to translation of the graphene nanoplatelets which would cause chain formation in the first orthogonal direction, and switched from the second orthogonal direction to the first orthogonal direction prior to translation of the graphene nanoplatelets which would cause chain formation in the second orthogonal direction.

6. The method of claim 5, wherein the electric field is switched in an amount of time from 25% to 75% of the amount of time for translation of the graphene nanoplatelets in the dispersion, and optionally from 40% to 60%, or 50% of the amount of time for translation.

7. The method of claim 6, wherein the produced composition comprises graphene nanoplatelets has alignment within the matrix material in two orthogonal directions to result in the planar alignment.

8. The method of claim 7, wherein the graphene nanoplatelets are oblate spheroids having a long axis and short axis, and the planar alignment is such that the long axis of the nanoplatelets aligns along the two orthogonal directions with the short axis being aligned along a third orthogonal direction of the matrix material.

9. The method of claim 8, wherein the composition is produced so as to avoid the formation of conductive chains of graphene nanoplatelets in the two orthogonal directions.

10. The method of claim 8, wherein the long axis is from 500 nm to 50 μm and the short axis is from 1 nm to 10 nm, and optionally the long axis is from 1 μm to 50 μm or from 2 μm to 25 μm, or from 5 μm to 25 μm, and optionally the short axis is from 2 nm to 10 nm, or from 5 nm to 10 nm or from 5 nm to 8 nm.

11. The method of claim 10, wherein the graphene nanoplatelets are present in an amount from 0.1 wt % to 5.0 wt % based on the total composition, optionally from 0.17 wt % or 0.3 or 0.5 wt % up to 4 wt %, or 3 wt %, or 2 wt % or 1.5 wt %.

12. A composition comprising graphene nanoplatelets in a matrix material wherein the graphene nanoplatelets have alignment within the matrix material in two orthogonal directions to result in planar alignment.

13. The composition of claim 12, wherein the matrix material is a thermosetting plastic, and optionally an epoxy.

14. The composition of claim 13, wherein the graphene nanoplatelets are oblate spheroids having a long axis and short axis, and the planar alignment is such that the long axis of the nanoplatelets aligns along the two orthogonal directions with the short axis being aligned along a third orthogonal direction of the matrix material.

15. The composition of claim 14, wherein the composition is produced so as to avoid the formation of conductive chains of graphene nanoplatelets in the two orthogonal directions.

16. The composition of claim 12, wherein the long axis is from 500 nm to 50 μm and the short axis is from 1 nm to 10 nm, and optionally the long axis is from 1 μm to 50 μm or from 2 μm to 25 μm, or from 5 μm to 25 μm, and optionally the short axis is from 2 nm to 10 nm, or from 5 nm to 10 nm or from 5 nm to 8 nm.

17. The composition of claim 16, wherein the graphene nanoplatelets are present in an amount from 0.1 wt % to 5.0 wt % based on the total composition, optionally from 0.17 wt % or 0.3 or 0.5 wt % up to 4 wt %, or 3 wt %, or 2 wt % or 1.5 wt %.
